(19) United States
(12) Patent Application Publication
(10) Pub. No.: US 2026/0208941 A1
(43) Pub. Date: Jul. 23, 2026

(54) COOLER ACCESSORIES

(71) Applicant: AOB Products Company, Columbia, MO (US)

(72) Inventors: Derek Wright, Columbia, MO (US); Nick Featherston, Columbia, MO (US); Michael Cottrell, Ashland, MO (US); James Tayon, Moberly, MO (US); Brian Steere, Columbia, MO (US)

(73) Assignee: AOB Products Company, Columbia, MO (US)

(21) Appl. No.: 19/453,905

(22) Filed: Jan. 20, 2026

Related U.S. Application Data
(60) Provisional application No. 63/747,614, filed on Jan. 21, 2025.

(51) Int. Cl. B65D 83/04; B65D 81/18; E05B 37/02

(52) U.S. Cl. CPC B65D 83/04; B65D 81/18; E05B 37/02

(57) ABSTRACT

A cooler assembly and associated components and methods. The cooler assembly may provide beverage dispensing functions and/or storage functions. In one embodiment, the cooler assembly includes a cooler, a beverage dispenser disposed in the cooler, and a security container releasably connected to the cooler. The beverage dispenser stores and dispenses beverage containers. The security container includes an interior compartment sized and shaped to receive one or more objects. The security container includes a door lock configured to selectively secure the door in the closed position.

### CROSS-REFERENCE TO RELATED APPLICATION

This application claims priority to U.S. Provisional Patent Application No. 63/747,614, filed January 21, 2025, which is hereby incorporated by reference in its entirety.

### FIELD

The present disclosure relates to coolers, and more particularly to cooler accessories.

### BACKGROUND

Coolers may be configured to provide functionality beyond temperature regulation of contents.

### SUMMARY

According to an aspect of the present disclosure, a cooler assembly is provided. The cooler assembly comprises a cooler having a base and a lid. The cooler has a security container mount on an exterior face of the base. The cooler assembly further comprises a security container releasably connectable to the security container mount. The security container includes a container housing defining an interior compartment sized and shaped to receive one or more objects. The security container includes a door movable between an open position where the door permits access to the interior compartment and a closed position where the door blocks access to the interior compartment. The security container includes a door lock configured to selectively secure the door in the closed position.

According to another aspect of the present disclosure, a cooler assembly for holding beverage containers is provided. The cooler assembly comprises a cooler having a base and a lid. The base has a cooler interior. The lid is movable between an open position where the lid permits access to the cooler interior and a closed position where the lid closes the cooler interior. The cooler assembly further comprises a beverage dispenser sized and shaped to be placed in the cooler interior of the cooler and to permit the lid to be arranged in the closed position when the beverage dispenser is disposed in the cooler interior. The beverage dispenser includes a housing having an interior sized and shaped to hold the beverage containers and having an access opening through which the beverage containers are movable. The beverage dispenser includes a beverage pusher configured to move the beverage containers toward the access opening.

According to another aspect of the present disclosure, a beverage dispenser for holding a plurality of beverage containers is provided. The beverage dispenser comprises a housing having an interior sized and shaped to hold the beverage containers and having an access opening through which the beverage containers are installed in the interior and removed from the interior. The beverage dispenser comprises a beverage pusher biased toward the access opening and configured to move the beverage containers in the interior toward the access opening. The interior may define an arcuate path configured to arrange beverage containers in the interior in an arcuate arrangement along the arcuate path. The beverage dispenser may comprise an actuator configured to be accessible by and engaged by a hand of a user to permit the user to actuate the actuator to move the beverage pusher against the bias of the beverage pusher to facilitate loading of beverage containers into the beverage dispenser. The housing of the beverage dispenser may include one or more windows different from the access opening configured to permit a user to view one or more of the beverage containers in the housing. The interior may be configured to arrange beverage containers in the interior in two columns of beverage containers, and the beverage pusher may be configured to engage the lowest beverage containers of the two stacks for biasing said lowest beverage containers toward the access opening.

The foregoing general description of the illustrative embodiments and the following detailed description thereof are merely exemplary aspects of the teachings of this disclosure and are not restrictive.

### BRIEF DESCRIPTION OF FIGURES

FIG. 1 is an elevation view of a cooler assembly according to an embodiment of the present disclosure;

FIG. 2 is a front perspective view of the cooler assembly;

FIG. 3 is a front perspective view of the cooler assembly with a lid at an open position;

FIG. 4 is a partially exploded view of the cooler assembly;

FIG. 5 is a front perspective view of a beverage dispenser according to an embodiment of the present disclosure;

FIG. 6 is a transparent view of the beverage dispenser of FIG. 5;

FIG. 7 is an elevation view of the beverage dispenser according to another embodiment of the present disclosure;

FIG. 8 is a transparent view of the beverage dispenser of FIG. 7;

FIG. 8A is a side elevation view of the beverage dispenser of FIG. 7;

FIG. 9 is an elevation view of the beverage dispenser according to yet another embodiment of the present disclosure;

FIG. 10 is a transparent view of the beverage dispenser of FIG. 9;

FIG. 11 is a partially exploded view of the cooler assembly showing a security container in a separated position from a cooler;

FIG. 12 is an exploded view of the security container;

FIG. 13 is a front perspective view of the cooler assembly with a door of the security container at an open position;

FIG. 14 is zoomed view of FIG. 13 showing a door lock of the door;

FIG. 15 is a front perspective view of the cooler assembly showing a connection between the security container and the cooler; and

FIG. 16 is similar to FIG. 15 but shows the security container as partially transparent.

Other objects and features of the present disclosure will be in part apparent and in part pointed out hereinafter.

### DETAILED DESCRIPTION

A cooler assembly according to embodiments of the present disclosure is configured to include accessories for providing enhanced functionality for users. The cooler assemblies can be configured to maintain contents at a desired temperature, such as keeping beverages and food items cold. Alternatively, or in addition, the cooler assembly may be configured to provide functionality beyond just cooling. For example, the cooler assembly may include one or more accessories to enhance the utility of the cooler for users in various settings (e.g., tailgating, camping, road trips, beach recreation, etc.). The cooler assembly may include accessories configured for storing and dispensing beverage containers and/or accessories configured for storing and securing objects outside the cooler.

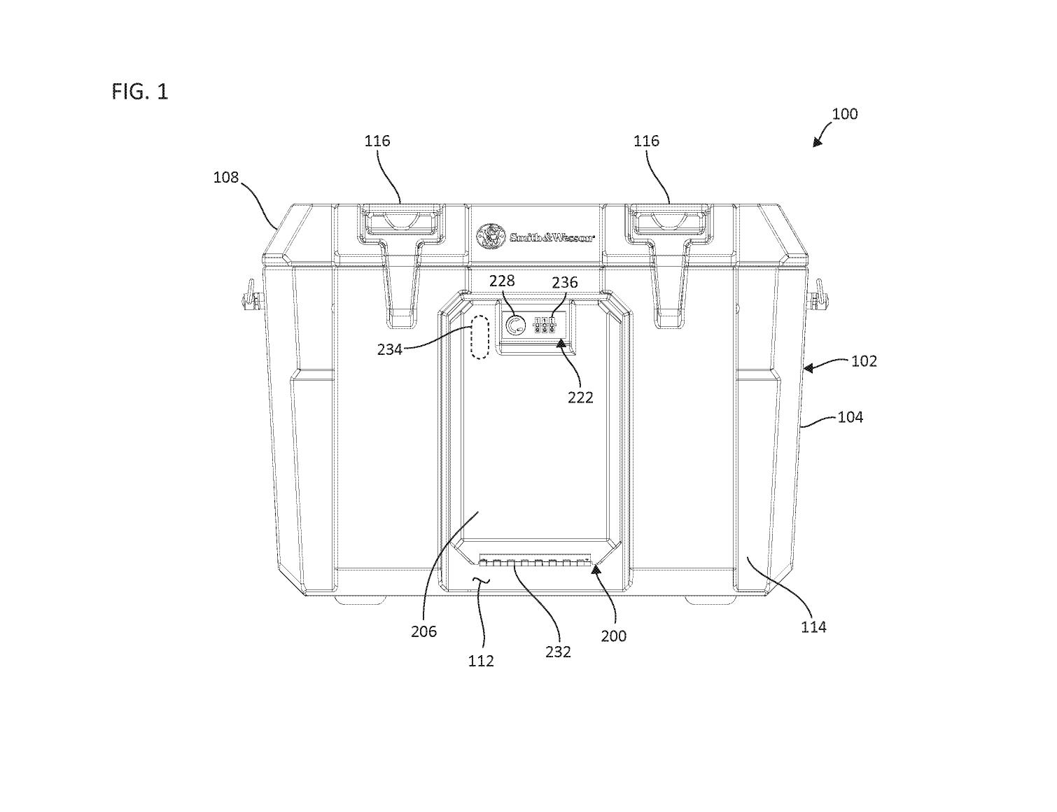

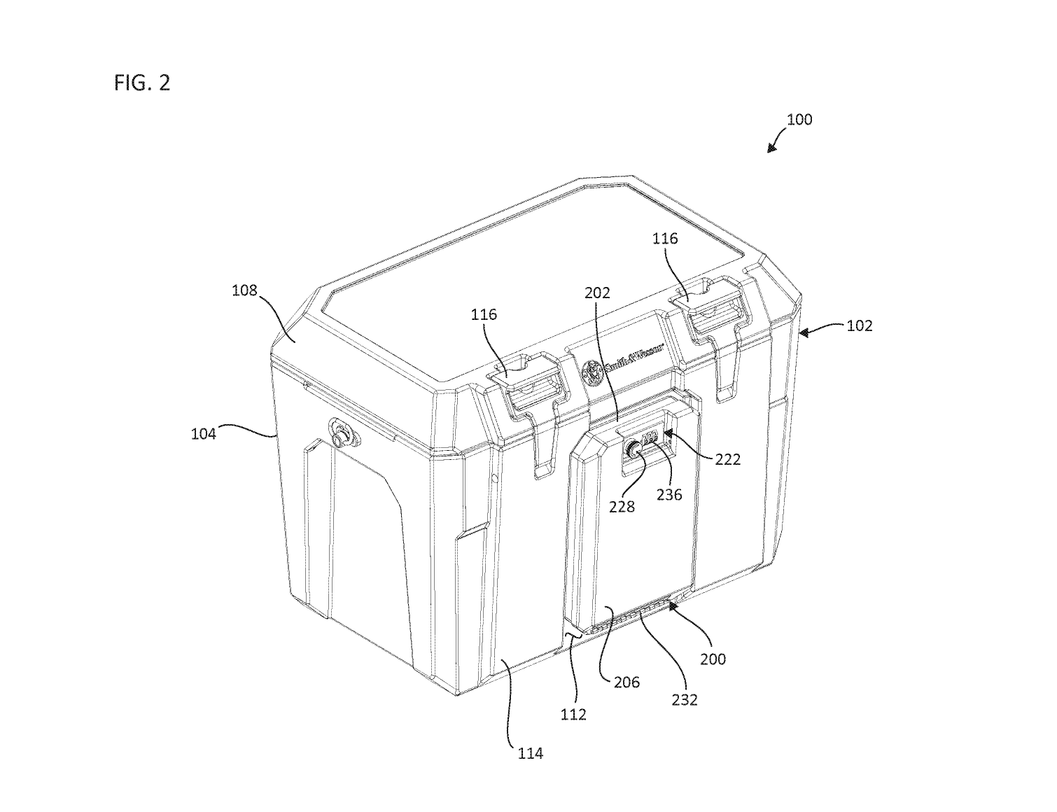

Referring to FIGS. 1-4, an example embodiment of the cooler assembly is generally indicated at reference number 100. The cooler assembly 100 broadly comprises a cooler 102, a security container 200, and a beverage dispenser 300. As will be more thoroughly described below, the cooler assembly 100 is configured to provide both beverage dispensing functionality and secure storage functionality.

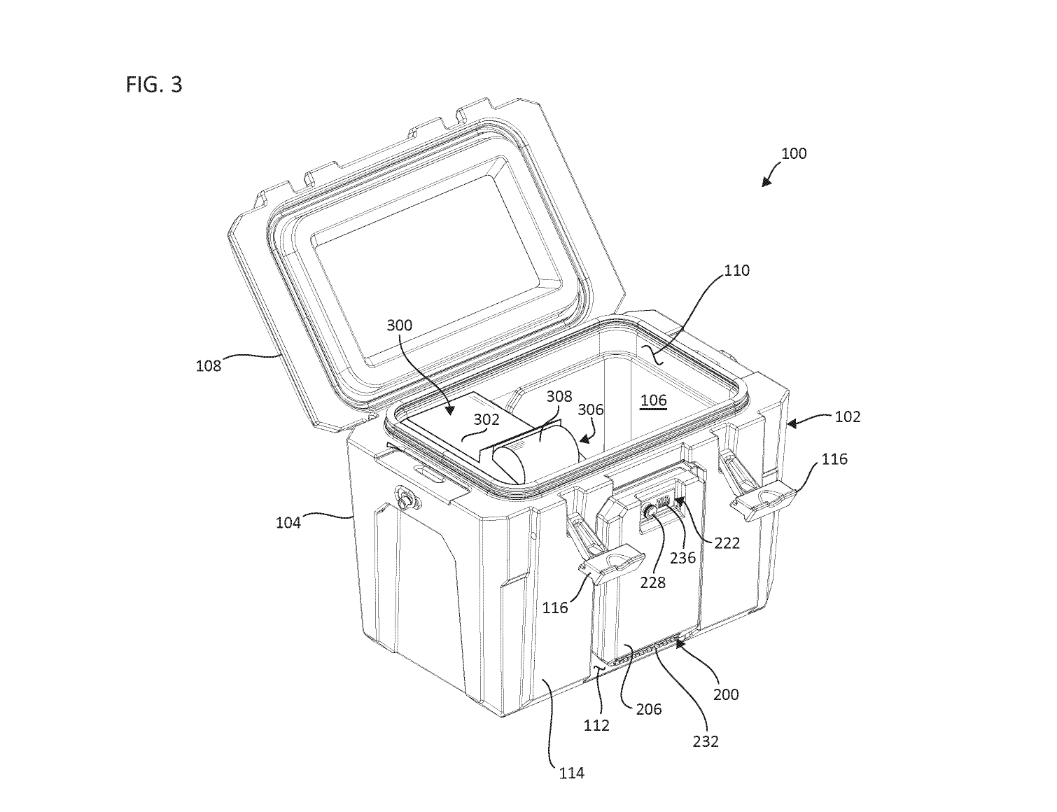

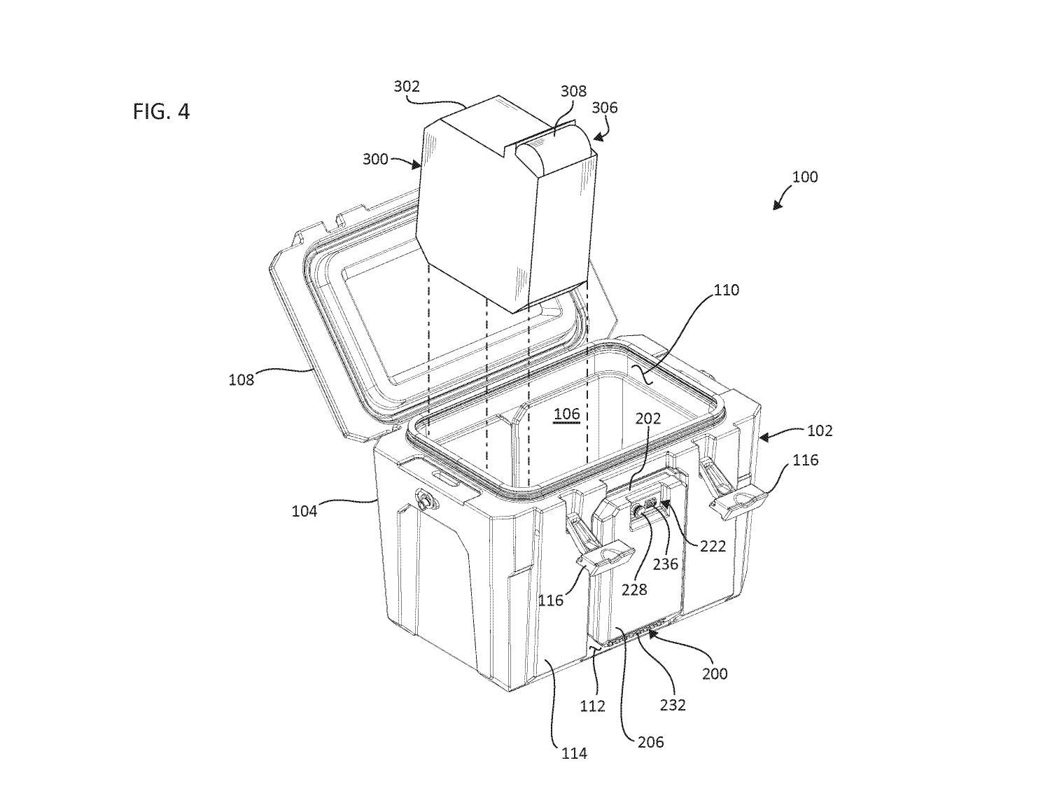

The cooler 102 includes a base 104 and a lid 108. The base 104 defines a cooler interior 106 sized and shaped to receive items to be maintained at a desired temperature. Desirably, the interior bounded by the base is configured to hold water to prevent water (e.g., melted ice) from leaking from the base. As shown in FIGS. 3 and 4, the cooler interior 106 is accessible through a lid opening 110 defined by the base 104. The lid 108 is movable between an open position wherein the lid permits access to the cooler interior 106 via the lid opening 110, and a closed position wherein the lid closes the lid opening to block access to the cooler interior. The cooler 102 includes lid latches 116 configured to secure the lid 108 to the base 104 when the lid is at the closed position. In the illustrated embodiment, the lid latches 116 are disposed on a single side of the cooler 102, however they may be positioned elsewhere on the cooler or omitted altogether.

The base 104 has an exterior face 114 (e.g., an outer surface). The base 104 defines a mount depression 112 at the exterior face 114. The mount depression 112 is configured to receive the security container 200, and has a security container mount 210 fixedly attached thereto. In other embodiments, the security container mount may be formed integrally with the body of the base 104. The security container 200 is releasably connectable to the exterior face 114 of the base 104 at the security container mount 210 for providing a secure storage compartment accessible from the exterior of the cooler 102. Further details regarding the security container 200 and the mounting arrangement thereof will be explained in greater detail later in the present disclosure.

As shown in FIGS. 3 and 4, the beverage dispenser 300 is configured to be disposed within the cooler interior 106 of the cooler 102. That is, the beverage dispenser 300 is sized and shaped to fit within the cooler interior 106 while permitting the lid 108 to be arranged at the closed position. The beverage dispenser 300 is insertable into and removable from the cooler interior 106 via the lid opening 110. In the illustrated embodiment, beverage containers 308 are positioned within the beverage dispenser 300 and are accessible to a user through the lid opening 110 when the lid 108 is at the open position.

The illustrated embodiment of the beverage dispenser 300 at FIGS. 3-6 generally comprises a rotary form factor with a housing 302 having an interior sized and shaped to store (e.g., hold) beverage containers 308 along an arcuate path (e.g., a circular path, a curved path). The beverage dispenser 300 includes an access opening 306 through which the beverage containers 308 are movable. For example, a user can insert and retrieve beverage containers 308 to and from the beverage dispenser 300 via the access opening 306. The beverage containers 308 are illustrated as cans, but may take other forms (e.g., bottles).

When the beverage dispenser 300 is disposed in the cooler interior 106, the beverage containers 308 within the beverage dispenser are maintained at a desired temperature by the cooler 102. For example, to keep the beverage containers 308 cool, the cooler interior 106 may be filled with ice; a user can thus open the lid 108 to access the cooler interior 106 and retrieve one or more chilled beverage containers 308 from the beverage dispenser 300 through the access opening 306. When the user closes the lid 108, the lid closes (e.g., seals) the lid opening 110 to block access to the cooler interior 106, thereby maintaining the temperature within the cooler interior.

Referring to FIG. 4, the beverage dispenser 300 is shown being inserted into/removed from the cooler interior 106 via the lid opening 110. The beverage dispenser housing 302 has dimensions that permit the beverage dispenser 300 to pass through the lid opening 110 when the lid 108 is at the open position, and to fit (e.g., snugly) in the cooler interior 106 (e.g., to form an interference fit or near interference fit with the cooler interior); a depth of the beverage dispenser housing 302 generally corresponds to a depth of the cooler interior 106, a height of the beverage dispenser housing generally corresponds to a height of the cooler interior, and a width of the beverage dispenser housing is less than (e.g., substantially less than) a width of the cooler interior such that multiple beverage dispensers 300 are positionable at the cooler interior simultaneously (e.g., in sequence) or such that other objects may be stored in the cooler alongside the dispenser. A user can insert the beverage dispenser 300 into the cooler interior 106 by lowering the beverage dispenser through the lid opening 110. Similarly, the user can remove the beverage dispenser 300 from the cooler interior 106 by lifting the beverage dispenser upward through the lid opening 110. A handle may be provided to ease user movement of the beverage dispenser 300. The beverage dispenser 300 is removable from the cooler interior 106 for various purposes, including reloading the beverage dispenser with beverage containers 308, cleaning, storing, etc.

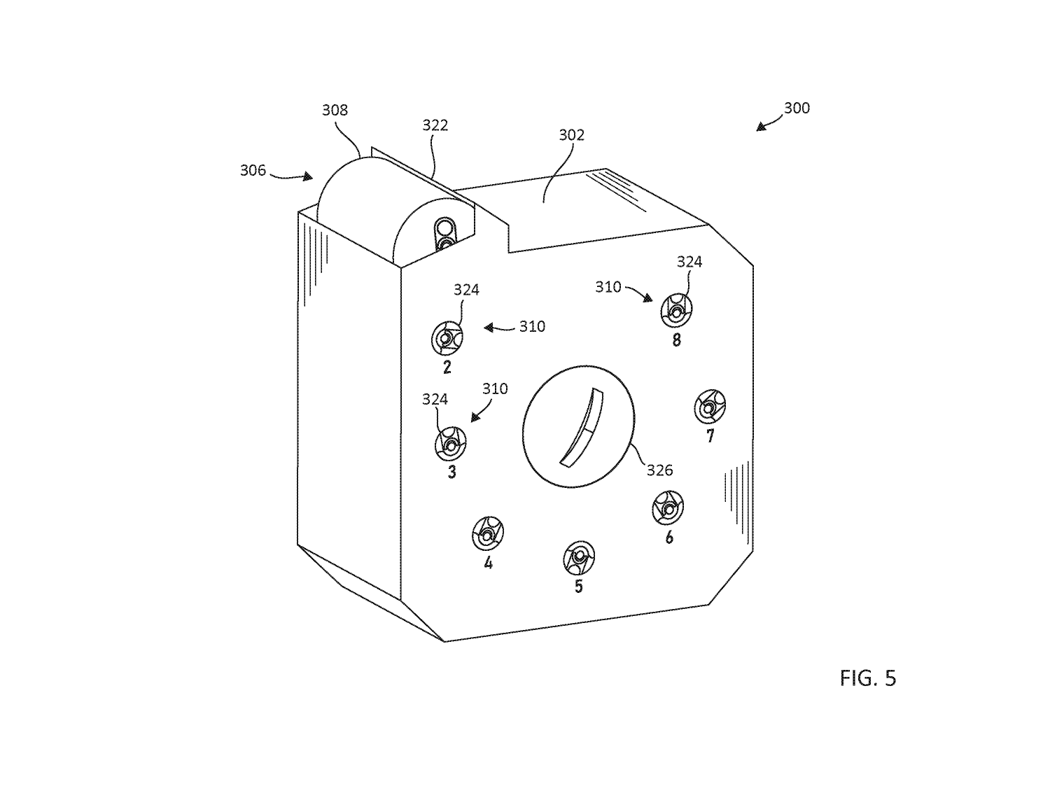

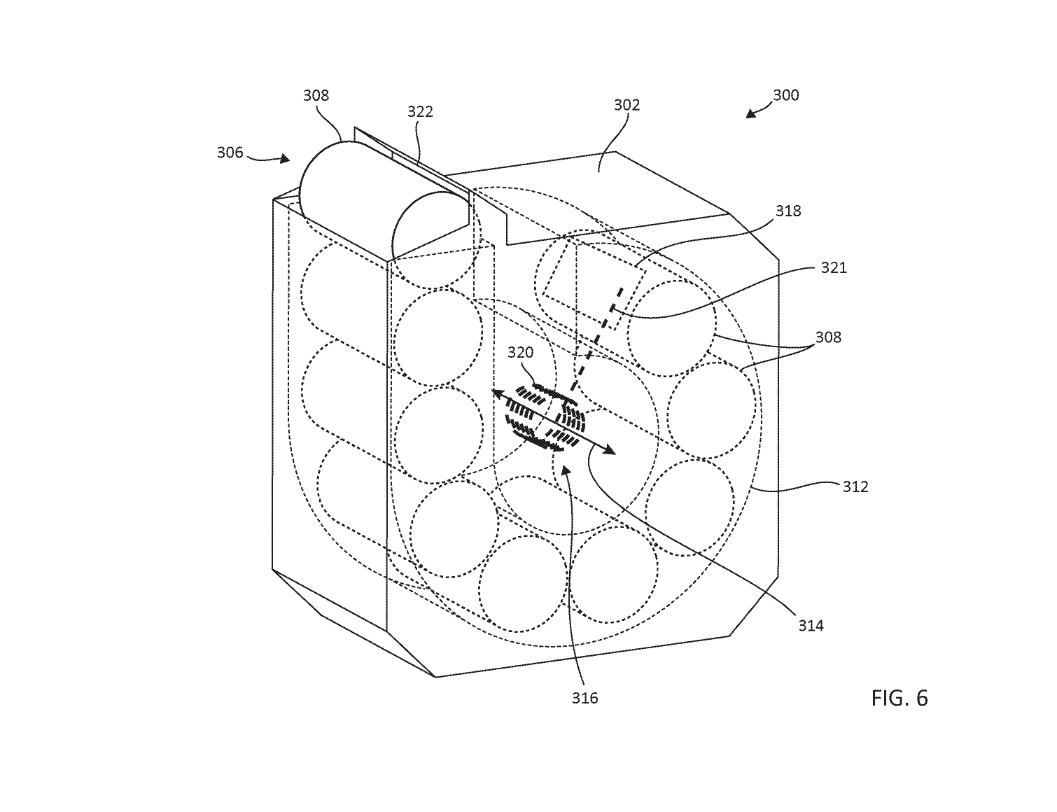

Referring to FIGS. 5 and 6, a more detailed depiction of the beverage dispenser 300 is provided. The beverage dispenser 300 includes components for driving motion of the beverage containers 308. Specifically, the beverage dispenser 300 comprises a beverage pusher 316 configured to move the beverage containers 308 toward the access opening 306. The interior of the housing 302 includes a beverage container guide 312 defining an arcuate path for the beverage containers 308 to travel along as the beverage containers move away from and toward the access opening 306. The interior of the housing 302 is configured to arrange the beverage containers 308 generally circularly around a center axis 314. The beverage containers 308 are positioned within the housing 302 such that the beverage containers 308 follow the arcuate path defined by the beverage container guide 312 as the beverage containers are loaded into the dispenser and as they advance toward the access opening 306.

The beverage pusher 316 includes a spring 320 and a beverage support 318 (broadly, plunger or follower) configured to engage at least one of the beverage containers 308. The spring 320 biases the beverage support 318 toward the access opening 306 to move the beverage containers 308 toward the access opening (e.g., about the center axis 314); specifically, the beverage support 318 engages the rearmost beverage container 308, and the spring 320 urges the beverage support in a rotational direction about the center axis 314, thereby advancing all of the beverage containers along the arcuate path toward the access opening 306.

In the illustrated embodiment, the spring 320 is a torsion spring having a spring arm 321 connected to the beverage support 318. The spring arm 321 extends radially outward from the spring 320 and through a channel at an inner surface of the beverage container guide 312 for permitting circumferential movement of the spring arm about the center axis 314. The torsion spring 320 is configured to apply a force on the beverage support 318 via the spring arm 321, urging the beverage support 318 in a rotational direction about the center axis 314 toward the access opening 306. In alternative embodiments, different springs may be employed (e.g., a compression spring).

The spring 320 is connected to a dial 326 (broadly, actuator) centrally positioned on the housing 302 at the center axis 314. The dial 326 provides user control over the spring. For example, when loading the beverage dispenser 300 with beverage containers 308, the user can turn the dial 326 to assist in overcoming the biasing force of the spring 320; by rotating the dial 326, the user reduces the resistance provided by the spring 320, making it easier to push beverage containers 308 past a retainer 322 and into the beverage dispenser 300.

The retainer 322 is configured to prevent the beverage containers 308 from moving through the access opening 306 unless manually retrieved by a user. As shown in FIGS. 5 and 6, the retainer 322 is disposed in proximity to the access opening 306. The retainer 322 provides resistance to hold the beverage containers 308 within the housing 302 against the bias of the spring 320 pushing the beverage containers 308 toward the access opening 306. When a user applies sufficient manual force to a beverage container 308 positioned at the access opening 306 (e.g., a removal force, an insertion force), the retainer 322 permits removal of the beverage container. The retainer can be static (e.g., fixed lip of the housing at the access opening) or may deflect or give way to permit the beverage container to pass through the access opening. Upon removal of one beverage container 308, the beverage pusher 316 advances the remaining beverage containers toward the access opening 306 to reposition the next beverage container at the access opening 306 for retrieval. Beverage containers 308 are loaded into the beverage dispenser 300 by pushing the beverage containers one-at-a-time through the access opening 306 and into the interior of the housing 302.

Referring to FIG. 5, the beverage dispenser 300 includes a plurality of container positions 310 arranged circumferentially about the dial 326. In the illustrated embodiment, the container positions 310 are numbered 2 through 8 and are arranged on a substantially planar face of the housing 302. Each container position 310 corresponds to a location within the interior of the housing 302 where a beverage container 308 is configured to be positioned. Further, windows 324 are provided for permitting a user to view one or more of the beverage containers 308 in the housing 302. The housing can be formed of opaque material such that the window is necessary to permit viewing of the beverage containers. The windows can be openings in the housing that are uncovered or are covered (e.g., by a transparent cover). Each window 324 is associated with and in registration with a respective container position 310. The windows 324 are configured as witness openings to permit a user to quickly assess the inventory of beverage containers 308 remaining in the beverage dispenser 300. For example, a user preparing to resupply the beverage dispenser 300 may visually inspect the windows 324 to determine how many container positions 310 are occupied and how many are not occupied. If the user observes that beverage containers 308 are visible through the windows 324 at container positions 2, 3, and 4, but no beverage containers are visible through the windows at container positions 5, 6, 7, and 8, the user may determine that four container positions are unoccupied and may retrieve four replacement beverage containers from a separate supply to reload the beverage dispenser 300. While the illustrated beverage dispenser 300 includes eight beverage container positions 310 (nine including the position at the access opening), more or fewer positions may be employed.

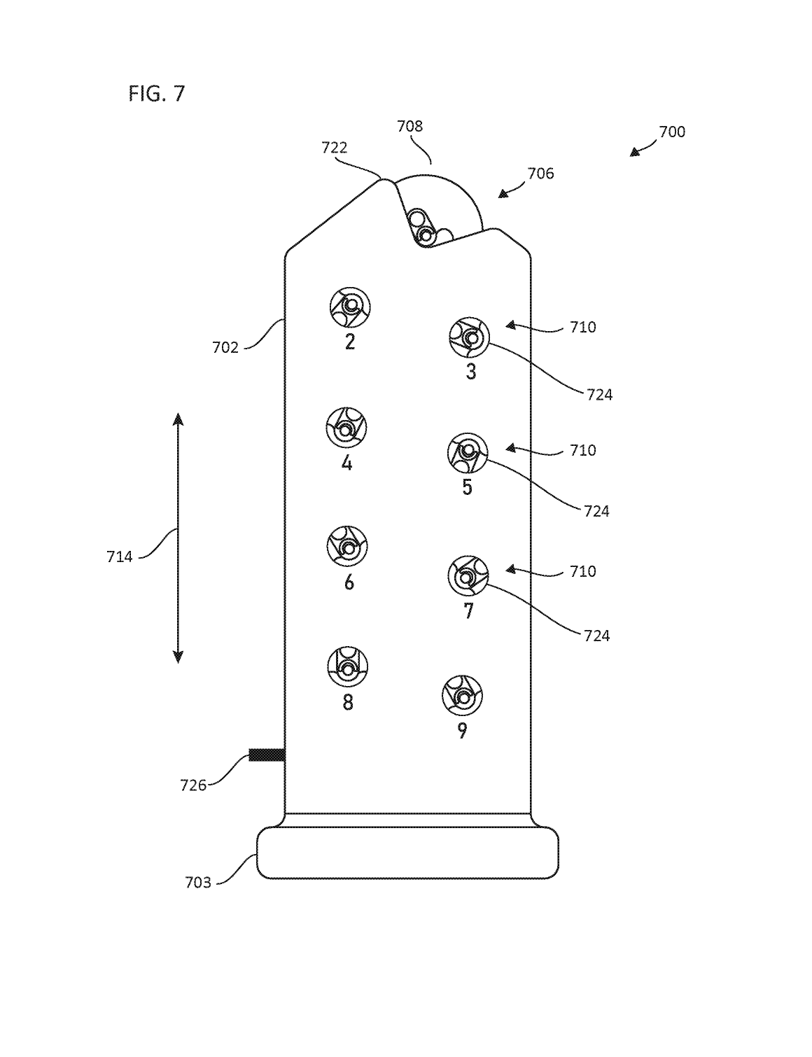

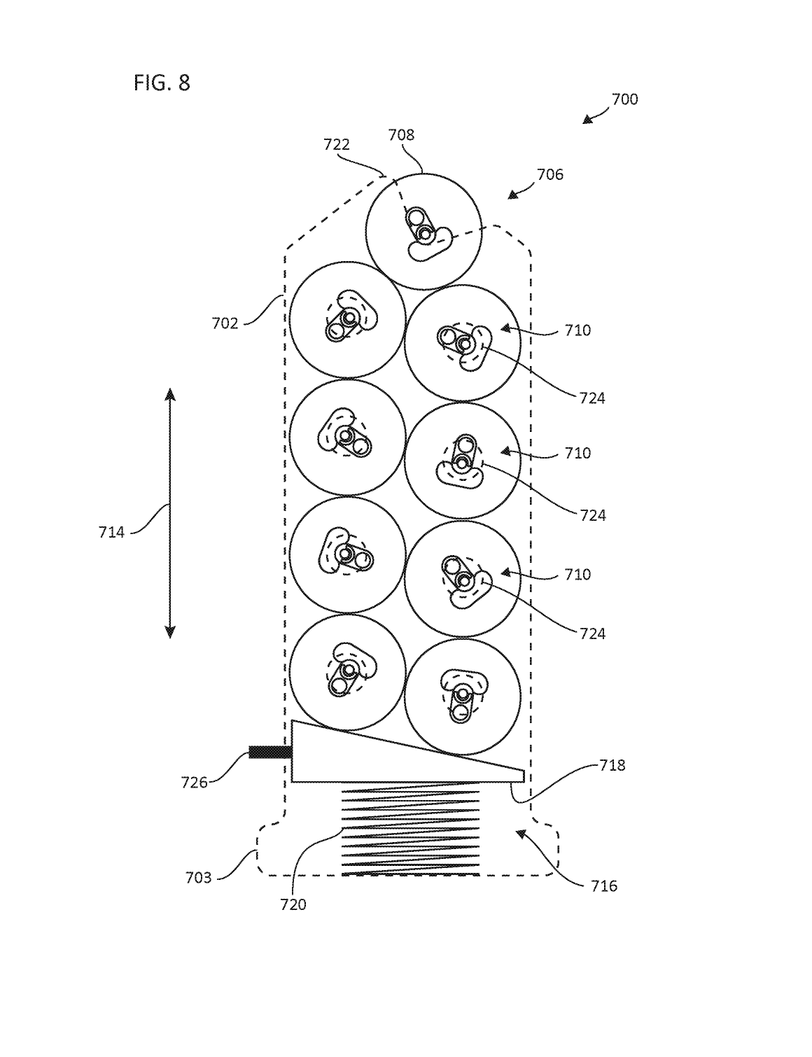

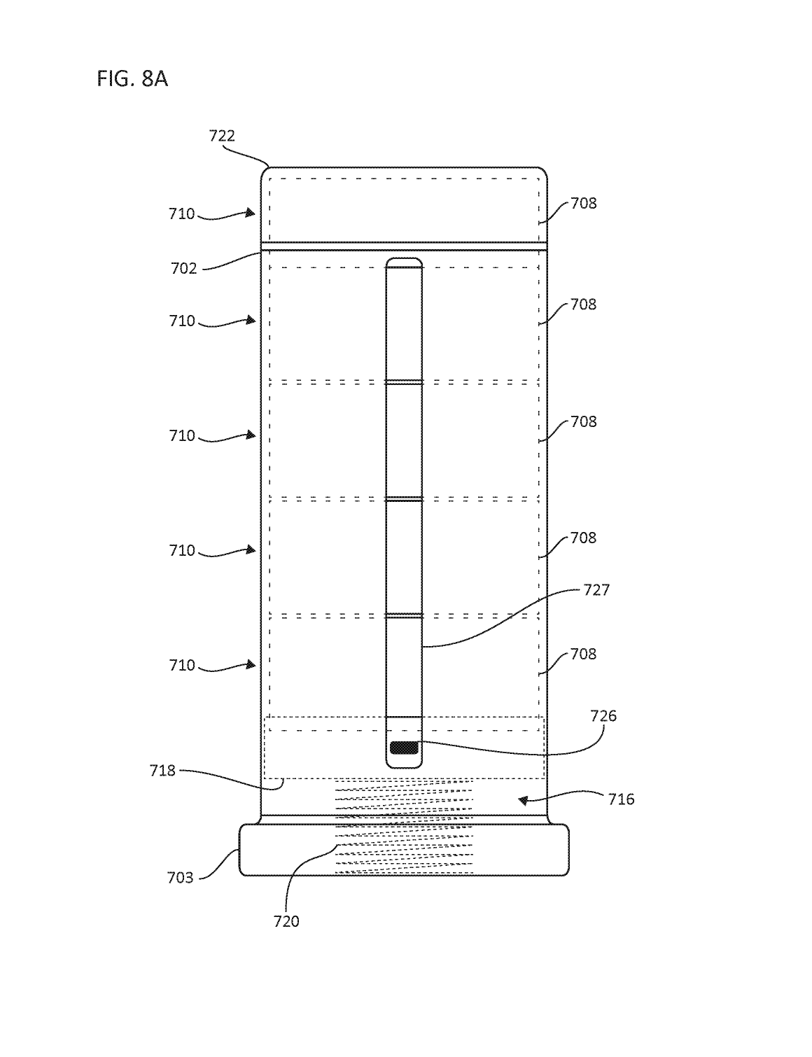

Referring to FIGS. 7-8A, another embodiment of a beverage dispenser is generally indicated at reference number 700. The beverage dispenser 700 performs similar functions to and includes similar components as the rotary beverage dispenser 300 described above, but arranges the beverage containers 708 in a generally upstanding stack configuration rather than a circular configuration. The beverage dispenser 700 broadly comprises a housing 702 having an interior sized and shaped to hold beverage containers 708 and having an access opening 706 through which the beverage containers are movable, and a beverage pusher 716 (broadly, plunger or follower) configured to move the beverage containers toward the access opening.

The housing 702 has an elongated form factor, extending along a vertical axis 714. The housing 702 includes a base 703 at a lower portion of the beverage dispenser 700. The interior of the housing 702 is sized and shaped to hold the beverage containers 708 arranged in two vertical columns along the vertical axis 714. The access opening 706 is located at an upper portion of the housing 702. Similarly to the rotary beverage dispenser 300, the beverage containers 708 are movable into the access opening 706 for loading and through the access opening 706 of the beverage dispenser 700 for retrieval by a user. The interior of the housing 702 defines a path configured to guide the beverage containers 708 to the access opening 706 in a first direction (broadly, an upward direction along the vertical axis 714). The housing 702 is configured to permit the beverage containers 708 to be retrieved through the access opening 706.

As shown in FIG. 8, the beverage pusher 716 includes a spring 720 and a beverage support 718 (broadly, a plunger or follower, a push surface) configured to engage at least one of the beverage containers 708. In the illustrated embodiment, the beverage support 718 engages the two lowermost beverage containers 708 in the stack. The beverage support 718 is configured to engage the lowermost beverage containers of each column of the stack and to position the lowermost beverage container of one stack lower than the lowermost beverage container of the other stack to assist with properly registering the columns of beverage containers relative to each other for proper feeding of the beverage containers to the access opening. The engagement of the beverage support 718 with the lowermost cans of both columns assists with movement of the stack upward with less friction than if just the lowermost can of the stack were engaged. The spring 720 biases the beverage support 718 toward the access opening 706 to move the beverage containers 708 toward the access opening. The spring 720 comprises a coiled compression spring arranged to push the beverage support 718 for advancing the beverage containers 708 upward. The spring 720 is connected to an actuator 726. The actuator 726 is coupled to the beverage support 718 and extends through the side of the housing to be accessible by the user outside the housing. For example, a slot 727 may be included. The slot 727 may have a closed upper end, a closed lower end, and a length that is upstanding and extends along the height of the housing 702 so the actuator 726 is moveable along the height of the housing in the slot and can be accessed by the user at various positions along the height. Alternatively, the user may reach into the slot 727 to access the actuator 726. The actuator 726 is similar to the dial 326 in that it provides user control of the spring 720. For example, when loading the linear beverage dispenser 700 with beverage containers 708, a user can actuate the actuator 726 to assist in overcoming the biasing force of the spring 720 (compressing the spring); by moving the actuator 726, the user reduces the resistance provided by the spring 720, making it easier to load beverage containers 708 past the retainer 722 and into the beverage dispenser 700. Other configurations can be used without departing from the scope of the present disclosure.

The retainer 722 is disposed in proximity to the access opening 706. The retainer 722 is configured to prevent the beverage containers 708 from moving through the access opening 706 unless manually retrieved by a user. The retainer 722 provides resistance that holds the beverage containers 708 within the housing 702 while the spring 720 biases the beverage containers 708 toward the access opening 706. When a user applies sufficient manual force to a beverage container 708 positioned at the access opening 706, the retainer 722 permits the beverage container to pass through the access opening. This is similar to the retainer 322.

Like the rotary beverage dispenser 300, the linear beverage dispenser 700 has a plurality of container positions 710. The container positions 710 are organized in two columns within the housing 702. The housing 702 includes a plurality of windows 724 configured to permit a user to view one or more of the beverage containers 708 in the housing 702. The beverage support 718 has a sloped geometry at an upper face thereof (or other suitable configuration) such that the beverage containers 708 are maintained at their respective container positions 710 and viewable through the windows 724 and both lowest beverage containers of the columns are engaged by and biased by the beverage support toward the access opening. Other configurations can be used without departing from the scope of the present disclosure.

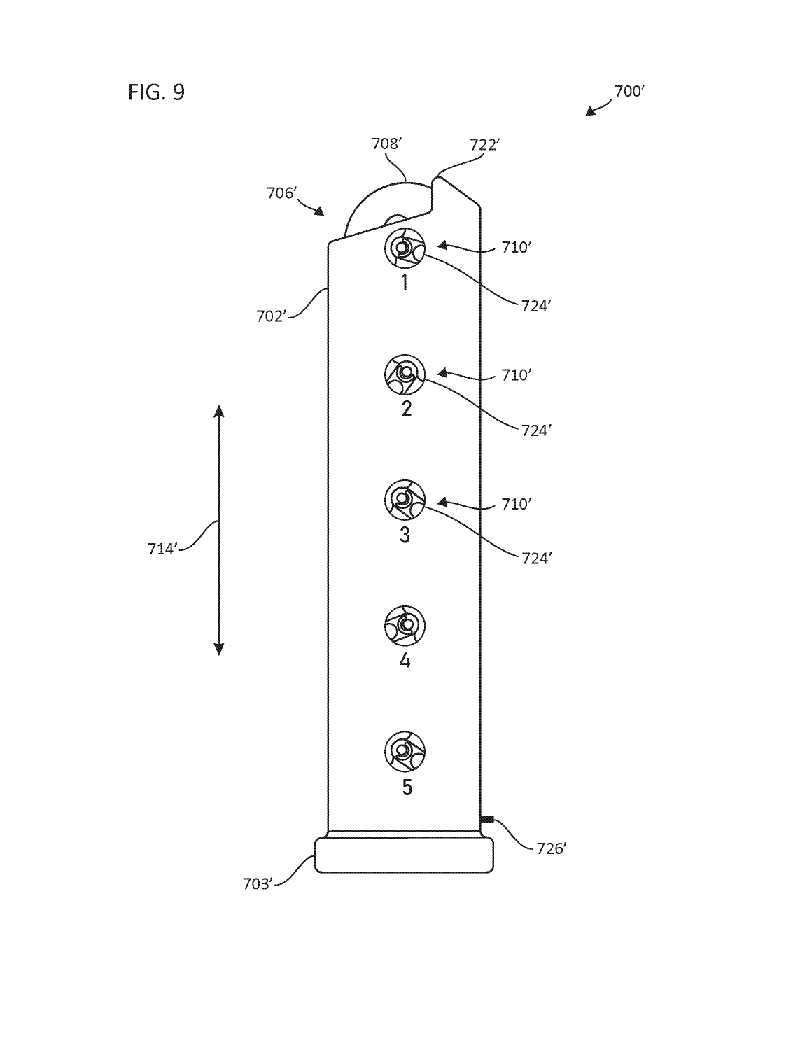

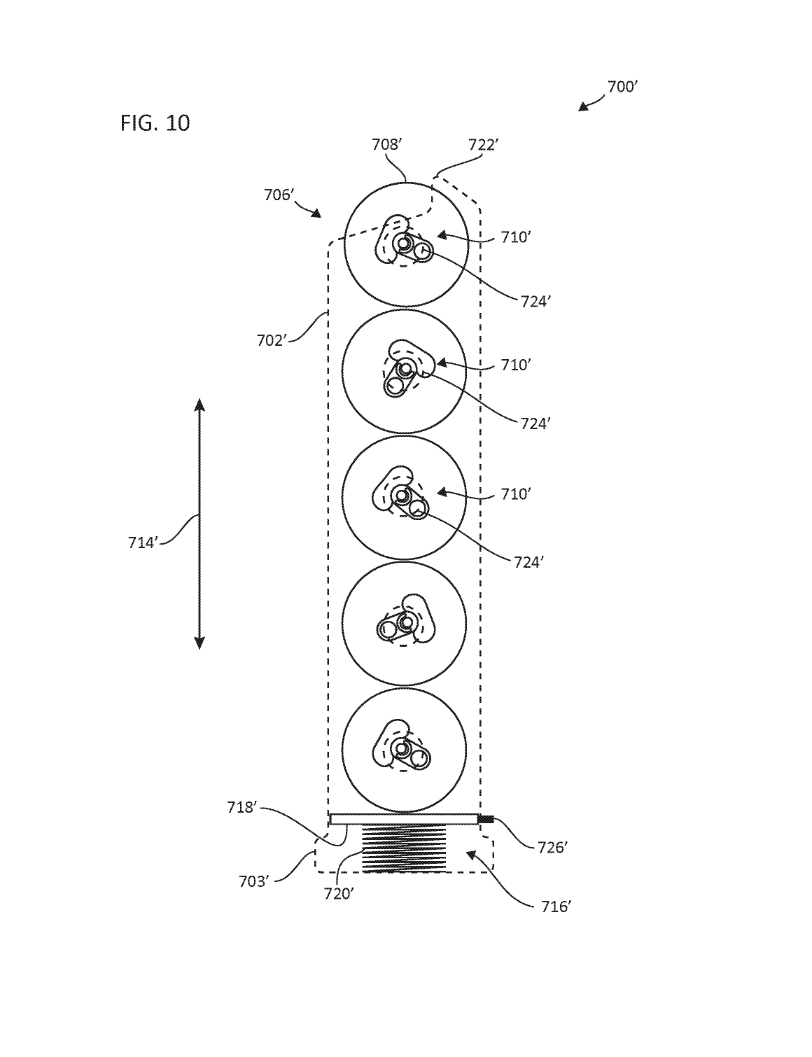

Referring to FIGS. 9 and 10, another embodiment of a beverage dispenser is indicated at 700’. The beverage dispenser 700’ is similar to the dispenser 700 described above, and like features are indicated with like reference numbers plus a prime designator. The dispenser 700’ is similar to the dispenser 700 except as follows. The dispenser 700’ is configured as a single column dispenser. In contrast to the multi column dispenser 700 described above with reference to FIGS. 7 and 8, the single column dispenser 700’ arranges the beverage containers 708 in a single file configuration within the housing 702’ along the vertical axis 714’. The beverage support 718’ (broadly, plunger or follower) engages a lowermost beverage container 708 in the single stack, thereby moving and biasing all of the beverage containers 708 in the stack toward the access opening 706’. The single column arrangement provides a more compact configuration compared to the double column embodiment while maintaining the upward biasing functionality of the beverage pusher 716’.

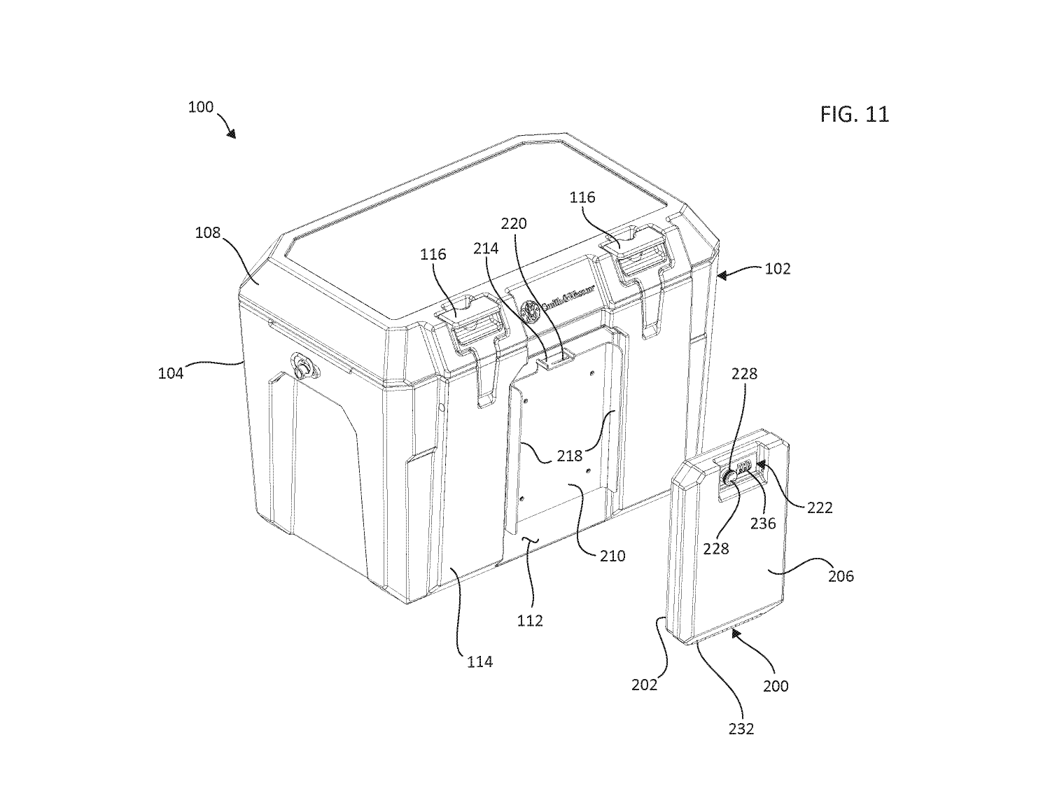

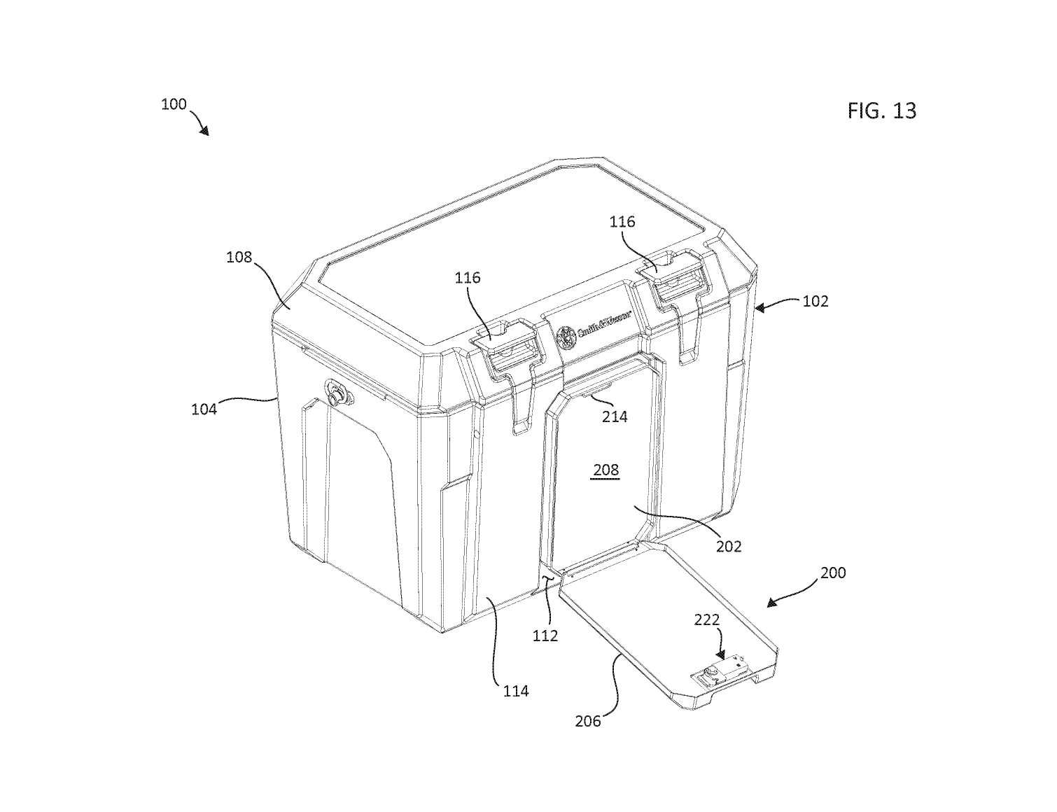

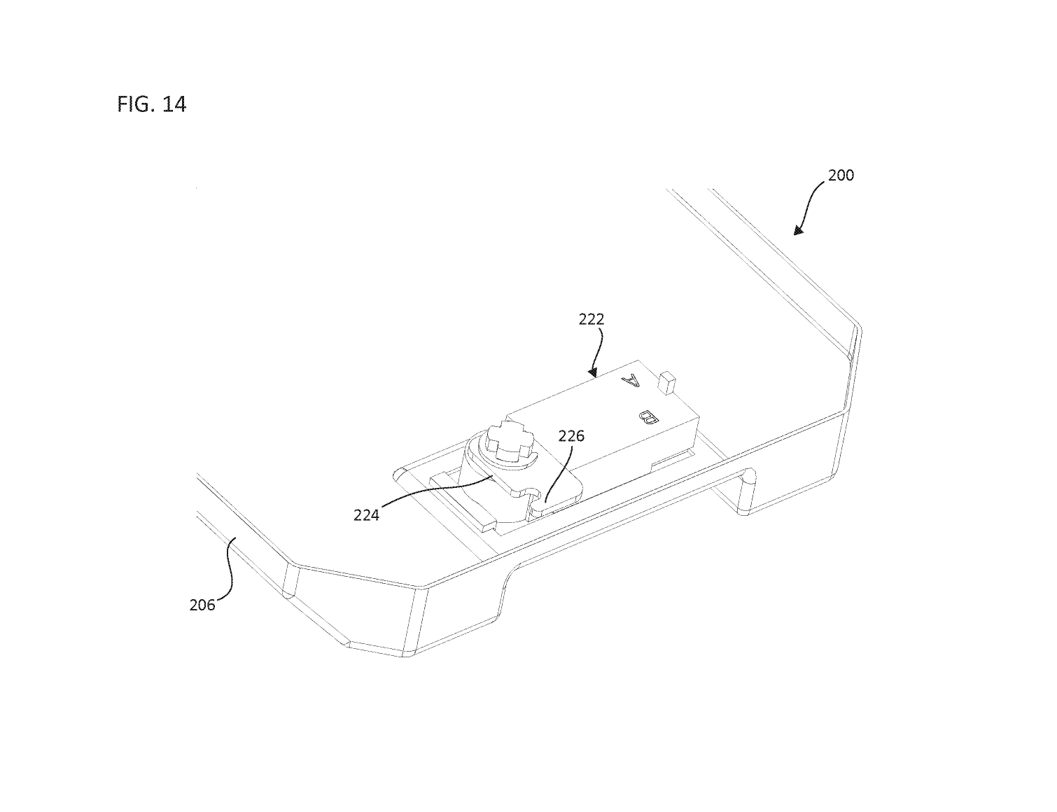

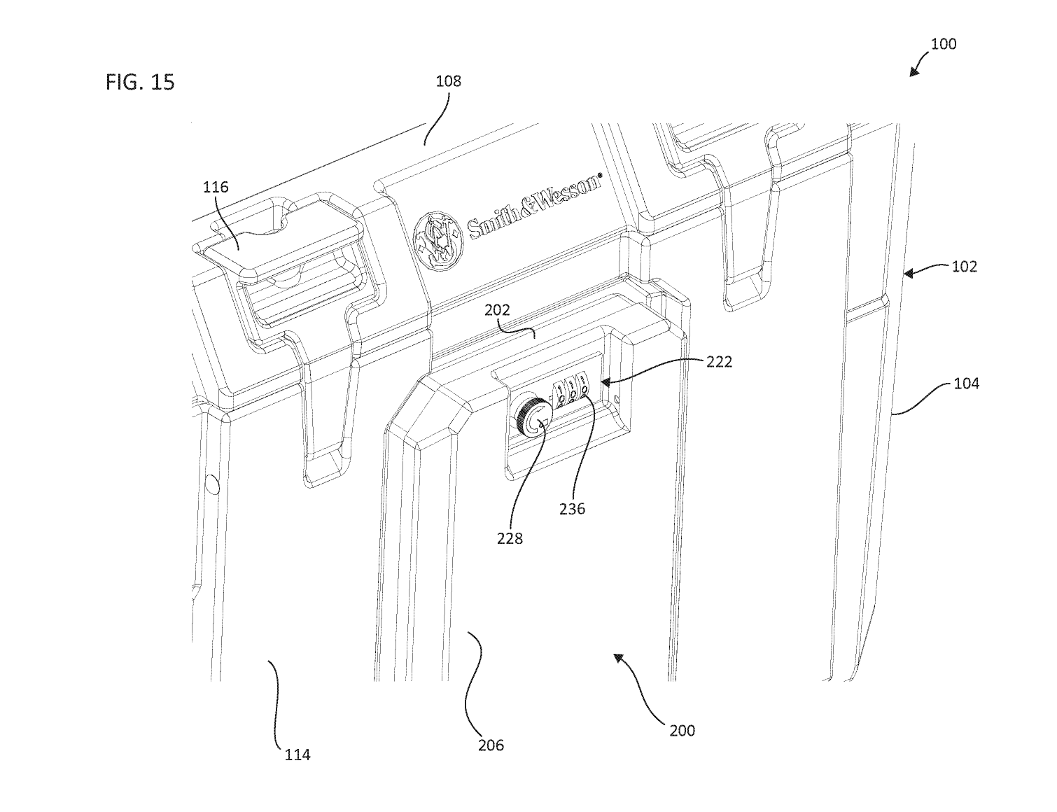

Having described the beverage dispenser (e.g., rotary beverage dispenser 300, single column and multi-column linear beverage dispensers 700, 700’), the disclosure will now turn to the security container 200. Referring to FIGS. 11-16, an embodiment of the security container 200 is shown both attached to and separate from the cooler 102. As will now be described in greater detail, the security container 200 provides a lockable compartment for storing objects on the exterior of the cooler 102.

The security container mount 210 is positioned on the exterior face 114 of the base 104 within the mount depression 112. The security container mount 210 includes mount connection openings for mounting and attaching the security container 200 to the cooler 102 using fasteners (e.g., locking tabs, loops, latches, screws, etc.). In some embodiments, the security container mount 210 is adhered to the cooler 102. A flange 218 extends outwardly from a perimeter 212 of the security container mount 210 and is arranged to brace the container housing 202 of the security container 200 when connected. The security container 200 can be

seen in a separated position from the cooler 102 at FIG. 11 to illustrate the attachment relationship between the security container 200 and the security container mount 210. Other configurations (e.g., mount formed integrally with cooler body) can be used without departing from the scope of the present disclosure.

The security container 200 includes a container housing 202 defining an interior compartment 208 sized and shaped to receive one or more objects (e.g., electronics, currency, firearms, keys, wallet, phones, etc.), providing a protected storage space accessible from the exterior of the cooler 102. The container housing 202 interfaces directly with the security container mount 210. A door 206 is movable between an open position where the door permits access to the interior compartment 208 and a closed position where the door blocks access to the interior compartment. The door 206 is connected to the container housing 202 via a hinge 232, allowing the door to pivot between the open and closed positions for placing or retrieving objects.

A door lock 222 is configured to selectively secure the door 206 in the closed position. The door lock 222 includes a locking mechanism and a latch actuator 228. In the illustrated embodiment, the locking mechanism is a combination lock 236, however alternative locking mechanisms may be employed (e.g., a biometric lock, a key lock, an electronic/digital lock, etc.). The latch actuator 228 is accessible from the exterior of the security container 200 when the door 206 is in the closed position and when the door lock 222 is in the locked state. The door lock 222 has a locked state wherein the latch actuator 228 is not operable to move a latch 224. The door lock 222 has an unlocked state where the latch actuator is operable to move the latch between a retaining position and a release position.

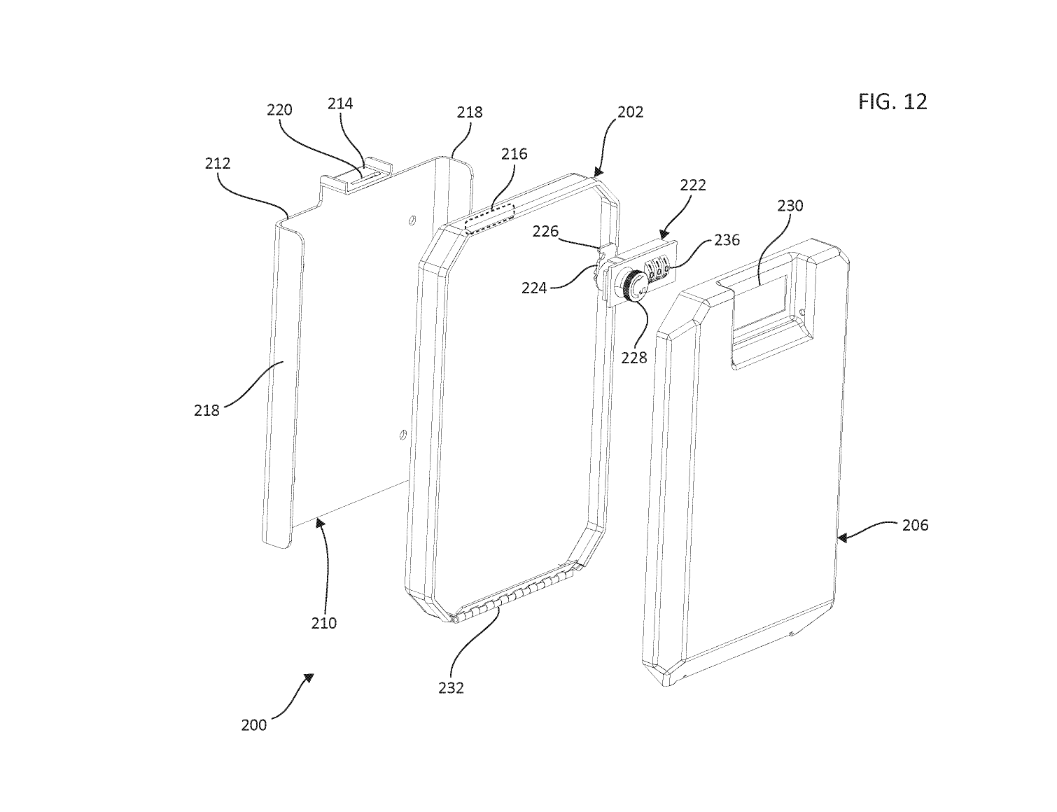

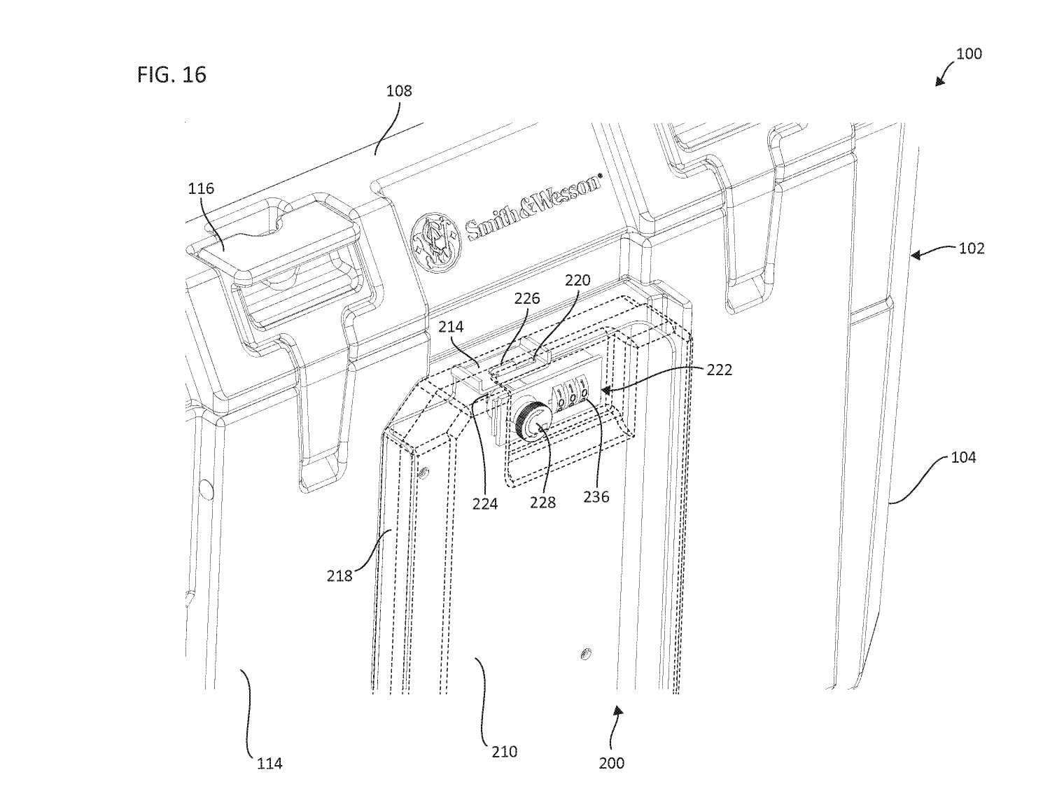

The security container mount 210 includes an insert 214 configured to be inserted into (e.g., into the interior compartment 208 of) the security container 200 when the security container is connected to the security container mount 210. The container housing 202 defines an insert receiver 216 (see FIG. 12) for receiving the insert 214. The insert 214 includes a latch receiver 220 configured to engage with the latch 224 of the door lock 222. The engagement between the latch 224 and the latch receiver 220 provides a dual function of retaining the door 206 in the closed position and retaining the security container 200 on the security container mount 210, as can be seen at FIG. 16.

The latch 224 includes a hook 226 configured to engage with the insert 214 when the latch is at the retaining position. When the latch 224 is at the retaining position, the latch is received by the latch receiver 220, and the hook 226 is above a planar portion of the insert 214; at the retaining position, the latch 224 secures both the security container 200 to the security container mount 210 and the door 206 at the closed position. When the latch 224 is at the release position, the latch is disengaged from the latch receiver 220, permitting the door 206 to move out of the closed position and permitting the security container 200 to be disconnected from the security container mount 210. The illustrated latch actuator 228 is a knob configured to be gripped by a user to move the latch 224 between these positions, however other latch actuator forms may be employed (e.g., a switch, a button, a lever, etc.).

The door lock 222 controls access to the security container 200 by requiring entry of credentials (e.g., a correct combination, key, or biometric information) before the latch actuator 228 is operable to release the latch 224 from engagement with the latch receiver 220 (e.g., to move the latch from the engaged position to the release position). In the illustrated embodiment, the combination lock 236 has three rotatable dials for entering a combination code, and the latch actuator 228 is positioned adjacent to the combination lock 236 on the door 206.

In the locked state of the door lock 222, the combination lock 236 does not receive the correct credentials, and prevents the latch actuator 228 from being operated, thereby inhibiting the latch 224 from moving out of the retaining position. In the unlocked state, a user is able to operate the latch actuator 228 to move the latch 224 from the retaining position to the release position. In some embodiments, the flange 218 of the security container mount 210 is flexible and/or forms an interference fit (e.g., a snug fit, a friction fit) with the housing 202 to hold the security container 200 such that it remains on the cooler 102 when the latch 224 is at the release position; the user can thus unlock the door lock 222 and open the door 206 without the security container 200 moving (e.g., falling, slipping) out of its position on the security container mount 210.

Referring to FIG. 1 optionally a retainer 234 is provided for securing the security container 200 and the security container mount 210 to one another. The retainer 234 may be one or more of a fastener, actuator, release, connector, or any other suitable device for maintaining the connection between the security container 200 and the security container mount 210. For example, the retainer 234 can be provided on the cooler and extend through respective openings in the mount and container to be accessible in the compartment 208 of the container. For example, the retainer 234 may include an oblong head rotatable between a retaining position (where the head obstructs removal of the mount and container) and a release position (where the container and perhaps the mount are removable off the retainer). Desirably, when the container and mount are assembled to the cooler, the retainer 234 is accessible only from within the interior compartment 208 of the security container 200. The retainer 234 acts similarly to the latch actuator 228, but does not inhibit opening of the door 206. If included, to release the security container 200 from the cooler 102 entirely, the user must actuate (e.g., rotate, push, release, depress, remove) the retainer 234 from within the interior compartment 208. Because the retainer 234 is accessible only from within the interior compartment 208, and because the door lock 222 secures the door 206 in the closed position when at the locked state, a person would need to have the credentials (key, password, passcode, or combination) to open the door and access to the retainer in order to remove the security container 200 from the cooler 102. The retainer 234 may be provided in addition to or in place of the latch actuator 228. In case of the latter, the door 206 may be configured to open immediately upon providing the correct credentials without actuation of any other component.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of the present disclosure or embodiments thereof, the articles "a," "an," "the," and "said" are intended to mean that there are one or more of the elements. The terms "comprising," "including," and "having" are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the present disclosure, and describes several embodiments, adaptations, variations, alternatives and uses of the aspects of the present disclosure, including what is presently believed to be the best mode of carrying out the aspects of the present disclosure. Additionally, it is to be understood that the aspects of the present disclosure are not limited in application to the details of construction and the arrangement of components set forth in the following description or illustrated in the drawings. The aspects of the present disclosure are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the present disclosure defined in the appended claims. As various changes could be made in the above constructions and methods without departing from the scope of the present disclosure, it is intended that all matter contained in the above description and shown in the accompanying drawings shall be interpreted as illustrative and not in a limiting sense.

In view of the above, it will be seen that several advantages of the aspects of the present disclosure are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A cooler assembly comprising:
a cooler having a base and a lid, the cooler having a security container mount on an exterior face of the base; and
a security container releasably connectable to the security container mount, the security container including:
a container housing defining an interior compartment sized and shaped to receive one or more objects;
a door movable between an open position where the door permits access to the interior compartment and a closed position where the door blocks access to the interior compartment; and
a door lock configured to selectively secure the door in the closed position

2. The cooler assembly of claim 1, wherein the security container mount includes an insert configured to be inserted into the security container when the security container is connected to the security container mount, the security container defining an insert receiver for receiving the insert.

3. The cooler assembly of claim 2, wherein the door lock is configured to engage the insert to at least one of:
selectively secure the door in the closed position; or
selectively secure the security container to the security container mount.

4. The cooler assembly of claim 3, wherein the door lock is configured to engage the insert to selectively secure the door in the closed position and to selectively secure the security container to the security container mount.

5. The cooler assembly of claim 3, wherein the insert includes a latch receiver, and wherein the door lock includes a latch moveable between a retaining position where the latch is engaged with the latch receiver to selectively secure the door in the closed position and/or selectively secure the security container to the security container mount and a release position where the latch is disengaged with the latch receiver to permit the door to move out of the closed position and/or to permit the security container to be disconnected from the security container mount.

6. The cooler assembly of claim 5, wherein the door lock includes a latch actuator configured to move the latch between the retaining and release positions.

7. The cooler assembly of claim 5, wherein the door lock has a locked state where the latch is inhibited from moving between the retaining and release positions and an unlocked state where the latch is moveable between the retaining and release positions.

8. The cooler assembly of claim 1, further comprising a retainer for securing the security container and the security container mount to one another, the retainer being accessible only from within the interior compartment of the security container when the security container is mounted to the security container mount.

9. The cooler assembly of claim 1, wherein the door lock comprises a combination lock.

10. The cooler assembly of claim 1, wherein the security container mount includes a flange extending outwardly from a perimeter of the security container mount, the flange arranged to brace the container housing of the security container when the security container is connected to the security container mount.

11. A cooler assembly for holding beverage containers, the cooler assembly comprising:
a cooler having a base and a lid, the base having a cooler interior, the lid being movable between an open position where the lid permits access to the cooler interior and a closed position where the lid closes the cooler interior; and
a beverage dispenser sized and shaped to be placed in the cooler interior of the cooler and to permit the lid to be arranged in the closed position when the beverage dispenser is disposed in the cooler interior, the beverage dispenser including:
a housing having an interior sized and shaped to hold the beverage containers and having an access opening through which the beverage containers are movable; and
a beverage pusher configured to move the beverage containers toward the access opening.

12. The cooler assembly of claim 11, wherein the cooler interior has a lid opening, the lid closing the lid opening when the lid is in the closed position, the beverage dispenser being insertable into and removable from the cooler interior via the lid opening.

13. The cooler assembly of claim 12, wherein the access opening is arranged to permit a user to retrieve the beverage containers from the beverage dispenser via the lid opening when the beverage dispenser is disposed in the cooler interior and the lid is at the open position.

14. The cooler assembly of claim 11, wherein the beverage pusher includes a follower configured to engage at least one of the beverage containers, the follower being biased toward the access opening to move the beverage containers toward the access opening.

15. The cooler assembly of claim 14, further comprising a retainer disposed in proximity to the access opening, the retainer configured to prevent the beverage containers from moving through the access opening unless manually retrieved by a user.

16. The cooler assembly of claim 11, wherein the interior of the housing defines an arcuate path configured to arrange beverage containers in the interior in an arcuate arrangement along the arcuate path.

17. The cooler assembly of claim 16, wherein the interior of the housing is configured to arrange the beverage containers along a generally semi-circular path, the pusher being arranged to bias the beverage containers along the generally semi-circular path toward the access opening.

18. The cooler assembly of claim 11, wherein the housing of the beverage dispenser includes one or more windows different from the access opening configured to permit a user to view one or more of the beverage containers in the housing.

19. The cooler assembly of claim 11, wherein the housing is configured to form an interference fit with the base of the cooler when the beverage dispenser is disposed in the cooler interior.

20. The cooler assembly of claim 11, wherein the beverage pusher is biased toward the access opening, and further comprising an actuator configured to be accessible by and engaged by a hand of a user to permit the user to actuate the actuator to move the beverage pusher against the bias of the beverage pusher to facilitate loading of beverage containers into the beverage dispenser.

21. The cooler assembly of claim 11, wherein the cooler interior has a length, a width, and a height, and the cooler interior length is greater than the cooler interior height.

22. The cooler assembly of claim 11, wherein the beverage dispenser is a first beverage dispenser and wherein the cooler interior is sized to receive a second beverage dispenser having the same construction as the first beverage dispenser.

23. A beverage dispenser for holding a plurality of beverage containers, the cooler accessory comprising:
a housing having an interior sized and shaped to hold the beverage containers and having an access opening through which the beverage containers may be installed in the interior and removed from the interior;
a beverage pusher biased toward the access opening and configured to move the beverage containers in the interior toward the access opening; and
at least one of:
wherein the interior defines an arcuate path configured to arrange beverage containers in the interior in an arcuate arrangement along the arcuate path;
the beverage dispenser further comprises an actuator configured to be accessible by and engaged by a hand of a user to permit the user to actuate the actuator to move the beverage pusher against the bias of the beverage pusher to facilitate loading of beverage containers into the beverage dispenser;
the housing of the beverage dispenser includes one or more windows different from the access opening configured to permit a user to view one or more of the beverage containers in the housing; or
the interior is configured to arrange beverage containers in the interior in two columns of beverage containers, and the beverage pusher is configured to engage the lowest beverage containers of the two stacks for biasing said lowest beverage containers toward the access opening.

24. The beverage dispenser of claim 23, wherein the interior defines the arcuate path configured to arrange beverage containers in the interior in an arcuate arrangement along the arcuate path.

25. The beverage dispenser of claim 23, further comprises the actuator configured to be accessible by and engaged by a hand of a user to permit the user to actuate the actuator to move the beverage pusher against the bias of the beverage pusher to facilitate loading of beverage containers into the beverage dispenser.

26. The beverage dispenser of claim 23, wherein the housing of the beverage dispenser includes the one or more windows different from the access opening configured to permit a user to view one or more of the beverage containers in the housing.

27. The beverage dispenser of claim 23, wherein the interior is configured to arrange beverage containers in the interior in the two columns of beverage containers, and the beverage pusher is configured to engage the lowest beverage containers of the two stacks for biasing said lowest beverage containers toward the access opening.
